(19) United States
(12) Patent Application Publication
(10) Pub. No.: US 2017/0133906 A1
(43) Pub. Date: May 11, 2017

(54) ELECTROMECHANICAL ACTUATOR

(71) Applicant: ZF Friedrichshafen AG, Friedrichshafen (DE)

(72) Inventors: Daniel PFEIFFER, Berg (DE); Martin HOFFMANN, Friedrichshafen (DE)

(21) Appl. No.: 15/323,470

(22) PCT Filed: Jun. 9, 2015
(86) PCT No.: PCT/EP2015/062798

§ 371 Date: Jan. 3, 2017

(30) Foreign Application Priority Data
Jul. 9, 2014 (DE) 10 2014 213 324.6

(51) Int. Cl. H02K 5/22; H02K 5/173; B60G 21/055; H02K 11/21

(52) U.S. Cl. CPC H02K 5/225; H02K 11/21; H02K 5/173; B60G 21/0555; B60G 2202/42

(57) ABSTRACT

An electromechanical actuator having an electric motor which comprises a rotor shaft (5) and a motor housing (2). A bearing plate (6) is supported inside the motor housing (2) for holding the rotor shaft (5). A cover (3) is arranged in front of the motor housing (2) and the bearing plate (6) and is connected to a stabilizer half (4). A component carrier (8) is arranged on and fixed to the bearing plate (6) for supporting electric and/or electronic components.

This application is a National Stage completion of PCT/EP2015/062798 filed Jun. 9, 2015, which claims priority from German patent application serial no. 10 2014 213 324.6 filed Jul. 9, 2014.

### FIELD OF THE INVENTION

The invention concerns an electromechanical actuator, which comprises an electric motor with a rotor shaft and a motor housing, a bearing plate supported in the housing for holding the rotor shaft, and a cover fitted at the front of the motor housing and bearing plate and connected to a stabilizer half.

### BACKGROUND OF THE INVENTION

EP 1 820 675 A1 by the present applicant describes an electromechanical actuator, also known as a swivel motor, for a stabilizer arrangement. The swivel motor comprises an electric motor and a planetary gearset with a large step-down ratio, which are accommodated in a common housing, the motor housing. A first stabilizer half is connected via a widened portion by means of a weld joint at the front of the motor housing, while a second stabilizer half is connected to the drive output of the planetary gearset. By activating the electric motor, i,e. rotating the rotor shaft, the two stabilizer halves can be rotated relative to one another, whereby active stabilization for the motor vehicle is achieved.

In the older application by the present applicant with file number 10 2013 215 859.9 an electromechanical actuator of an active roll stabilization system for motor vehicles is disclosed, wherein in particular the connection of a cable harness for the transmission of power and signals for the electric motor and a sensor unit is illustrated and described. In that case the cable harness is connected to the electric motor by means of a first plug attached at the front on a cover, and to the on-board electrical system of the vehicle by means of a positionally fixed second plug.

### SUMMARY OF THE INVENTION

The purpose of the present invention is to further improve an electromechanical actuator of the type mentioned to begin with, such that in particular the requirements relevant for the operation of a motor vehicle such as dust-tightness and water-tightness are fulfilled.

The objective of the invention is achieved by the characteristics and advantageous design features described below.

According to the invention, it is provided that a component carrier for electric and/or electronic components is arranged on and attached to the bearing plate. The component carrier, which is in a closed space between the bearing plate and the cover sealed relative to the outside, serves to hold, attach, fix and center various components needed for the operation and control of the electric motor, in particular a roll stabilization system. By using the component carrier advantages are obtained, relating in particular to assembly and the connection of the individual components, i.e. assembly is made simpler and quicker and even blind assembly is possible. Moreover, a further advantage is that the individual components are positioned precisely, on the one hand relative to one another and on the other hand relative to the electromechanical actuator.

In a preferred embodiment a first component is in the form of a power plug by means of which the electric motor is supplied with electric power. The component carrier ensures that the plug can be fitted simply so that by way of plug contacts the electric motor is supplied with electric current in a reliable and trouble-free manner.

According to a further preferred embodiment a second component is designed as a signal plug by way of which signals, in particular angle positions for the control of the electric motor, are transmitted.

In another preferred embodiment a third component is designed as a sensor unit, which comprises a sender and a receiver element. By means of the sensor unit the angular position of the rotor shaft is controlled, i.e. the relative rotational angle between the two halves of the stabilizer.

According to a further preferred embodiment a fourth component is in the form of a printed circuit board which serves as a support for electronic components and interconnection pathways, i.e. electrical connections between the components. The printed circuit board essentially functions as an electronic control unit.

According to a further preferred embodiment the component carrier has a first centering surface arranged coaxially with the rotor shaft, which engages with another centering surface on the bearing plate. By means of this first centering surface the component carrier is centered relative to the rotational axis of the rotor shaft.

In another preferred embodiment the component carrier has a second centering surface which is eccentric, i.e. arranged axially offset, which engages with an axially offset motor contact system (motor connection contacts) and is therefore secured in the circumferential direction, i.e. against twisting. By virtue of the first and second centering means the component carrier is sufficiently exactly positioned relative to the bearing plate.

According to a further preferred embodiment, the component carrier has a first plug collar, which serves to receive the power plug or the plug contacts of the power plug. Thus, the plug collar constitutes the “plug socket” (female contact) for the plug itself (male contact).

In a further preferred embodiment, the component carrier has a second plug collar that serves to receive the signal plug. The first and second plug collars are preferably arranged on the component carrier offset relative to one another by around 90 degrees in the circumferential direction.

According to another preferred embodiment, in the first plug collar lamellar contacts are arranged for the electrical connection between the power plug and the motor contacts, also called power contacts. As mentioned above, the lamellar contacts are the female contacts and are connected to the motor contacts so as to conduct electricity, preferably by way of a welded or soldered joint.

According to a further preferred embodiment, the lamellar contacts are supported against the bearing plate by means of a plastic element arranged at the end. In that way the plug-in force produced when the power plug is pushed home are transferred directly to the bearing plate so that the motor contacts, which are arranged axially offset relative to the lamellar contacts, are not stressed by the plug-in force.

In a further preferred embodiment, at the front the cover has a first opening for receiving the power plug and the first plug collar. The opening has different cross-sections respectively adapted for the first plug collar and for the power plug, i.e. its cross-section is stepped.

In another preferred embodiment, the cover has, at the front and offset in the circumferential direction relative to the first opening, a second opening for receiving the second plug collar and the signal plug. Both of the plugs inserted from the outside into these openings, namely the power and the signal plug, are sealed against the cover so that no dirt, moisture or water can make its way from outside into the area of the component carrier and thereby affect the electronics. The actuator is thus capable of fording through shallow water, i.e. the penetration of water is prevented if the vehicle reaches its maximum permitted fording depth.

According to a further preferred embodiment, the sender element is connected to the rotor shaft, preferably to its end, and is arranged within the first centering surface of the component carrier. Thus, the sender element is sufficiently well protected against corrosion by the component carrier, and is in particular sealed against dust and oil relative to the motor space, wherein optionally an additional seal could also be provided.

In a further preferred embodiment, the receiver element is arranged on the printed circuit board coaxially with the sender element, i.e. with the rotational axis, and attached thereto. A defined air gap in the axial direction can then be left between the sender and receiver elements.

According to another preferred embodiment, the component carrier is screwed to the bearing plate. In this way the component carrier ensures secure holding and exact positioning of the electric and electronic components fixed on it.

In a further preferred embodiment, between the power contacts and the printed circuit board there is arranged a weld protection shield that projects in the axial direction. This blocks off any flying sparks when a material-merged connection is being formed between the power contacts and the lamellar contacts, in particular when welding. Thus, the printed circuit board and the electronic components and conducting paths arranged on it are protected during assembly.

According to a further preferred embodiment, the printed circuit board is connected to the component carrier by hot-stamping. The carrier can be an injection-molded plastic, or a metallic, or even a composite component. In the method of hot-stamping, which is known per se, the plastic material is melted under the action of heat, deformed and joined with interlock to the counter-component, in this case the printed circuit board. The advantage of this is that no additional fixing elements such as screws are needed,

### BRIEF DESCRIPTION OF THE DRAWINGS

An example embodiment of the invention is illustrated in the drawing and will be described in more detail below, so that further features and/or advantages may emerge from the description and/or the drawings. The drawings show:

FIG. 1: An axial section showing part of an actuator with component carrier and power plug,

FIG. 2: The axial section according to FIG. 1, with centering surfaces,

FIG. 3: A view from above, of the component carrier with plug collars,

FIG. 4: An exploded view of the actuator with component carrier and cover, and

Fig, 5: A further axial section, with the signal plug.

### DETAILED DESCRIPTION OF THE PREFERRED EMBODIMENTS

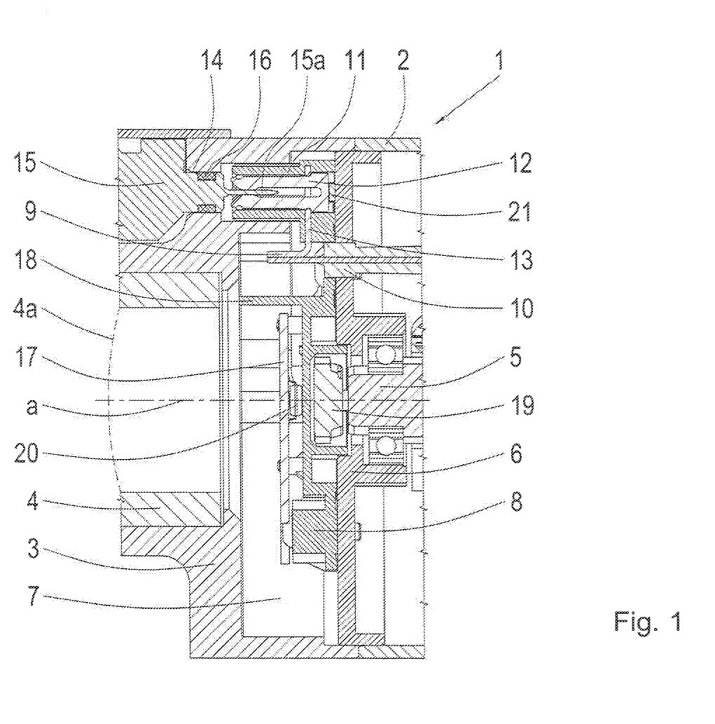

FIG. 1 shows the front end of an electromechanical actuator 1, designed as the swivel motor 1 of an active roll stabilization system for motor vehicles. The actuator 1 comprises a motor housing 2, which is closed at the front by a cover 3 connected to a first stabilizer half 4, preferably by a material-merging method. The motor housing 2 is connected at the front to the cover 3, again preferably by a material-merging method, since during the operation of the active roll stabilization, torques from the motor housing 2 are transmitted to the stabilizer half 4. As is known from the prior art mentioned earlier, in addition to the electric motor the actuator comprises a planetary gearset with a drive output to which a second stabilizer half (not shown) is attached. Of the electric motor, only the rotor or motor shaft 5 is shown here, the shaft stub of which is held in a bearing plate 6. The motor housing 2 and the stabilizer half 4 are arranged coaxially relative to the rotational axis a of the rotor shaft 5. The cover 3 and the bearing plate 6 delimit a hollow space 7, also called the electronic space 7, in which a component carrier 8 for various electrical and electronic components is arranged. On one side, the hollow space 7 is sealed off relative to the outside (from the atmosphere), the stabilizer 4, made in the form of a tube, being sealed off from the outside as indicated by a sealing wall represented by a broken line 4a. On the other side, the hollow space 7 is sufficiently well sealed relative to the motor space (not indexed). The electric motor has motor contacts or power contacts 9, which pass with their axes parallel through the bearing plate 6 and are held and sealed in the bearing plate 6 by an insulating body 10. The component carrier 8 has a first plug collar 11 in which lamellar contacts 12 (female contacts) are accommodated. The lamellar contacts 12 can conduct electricity by way of electrical conductors 13, and are connected to the motor or power contacts 9, preferably by a material-merged joining method such as welding or soldering. The cover 3 has a first opening 14 into which a power plug 15 is inserted. The power plug 15 has power contacts 15a (male contacts), which are plugged into the lamellar contacts 12 and so form an electrically conducting plug connection to the motor contacts 9. The power plug 15 is sealed relative to the cover 3 and fixed therein by sealing elements, preferably pressure ridges 16. A printed circuit board 17 is attached to the component carrier 8, whose board plane is orientated perpendicularly to the rotational axis a. The printed circuit board serves to accommodate electronic components and conducting paths, and is preferably joined to the component carrier 8 by hot-stamping, i.e. without the use of additional fastening elements. The component carrier 8 has a weld protection shield 18 that projects with a parallel axis between the motor contacts and the printed circuit board 17, which during the process of welding the motor contacts 9 to the conductors 13, is intended to prevent flying sparks and possible damage to the printed circuit 17. At the end, the motor shaft 5 of the electric motor is a sender element 19 in the form of a sender magnet 19, which is connected in a rotationally fixed manner to the rotor shaft 5 and thus rotates within a cylindrical recess of the component carrier 8. To the printed circuit board 17 is attached a receiver element 20, which is orientated coaxially with the sender element 19 and the rotational axis a. In combination with the receiver element 20. the sender element 19 forms a sensor unit for controlling and detecting the rotational angle between the two halves of the stabilizer. Between the lamellar contacts 12 and the bearing plate 6 there is arranged a plastic element 21, which transfers a plug-in force acting on the lamellar contacts 12 (when the power plug 15 is pushed home) directly to the bearing plate 6. This prevents stressing of the motor contacts 9 arranged offset and axially parallel.

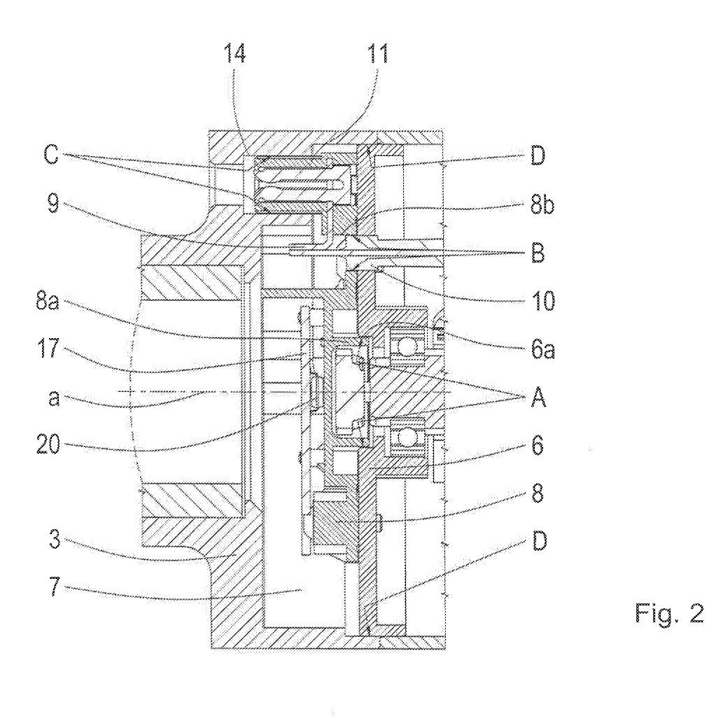

FIG. 2 shows the axial section as in FIG. 1, but in FIG. 2 the individual centering pairs are indexed with capital letters A to D. The component carrier 8 is centered relative to the bearing plate 6 by the surfaces indexed A. For this, the component carrier 8 has a hollow-cylindrical extension 8a (centering extension 8a) with a cylindrical outer surface, and the bearing plate 6 has a cylindrical recess 6a into which the centering extension 8a is inserted. If necessary, a suitable seal can also be positioned here so that the electronic space 7 is completely sealed relative to the motor space. In addition, at the points indexed B the component carrier 8 is fixed relative to the bearing plate 6 in the circumferential direction, whereby rotational centering is achieved. At that point the component carrier 8 has an opening 8b into which the insulating body projects. In this respect the component carrier 8 is directed toward the motor contacts 9. That orientation applies analogously to the receiver or reception element 20 attached to the printed circuit board 17, relative to its zero position. At the points indexed C, the cover 3 is centered in the circumferential direction with the first plug collar 11 of the component carrier 8, and on the outer circumference of the first plug collar 11 sealing elements, preferably in the form of pressure ridges, are provided in order to form a seal relative to the opening 14. The cover 3 is centered relative to the bearing plate 6 by a fit between the outer diameter of the bearing plate 6 and the diameter of the bore in the cover 3.

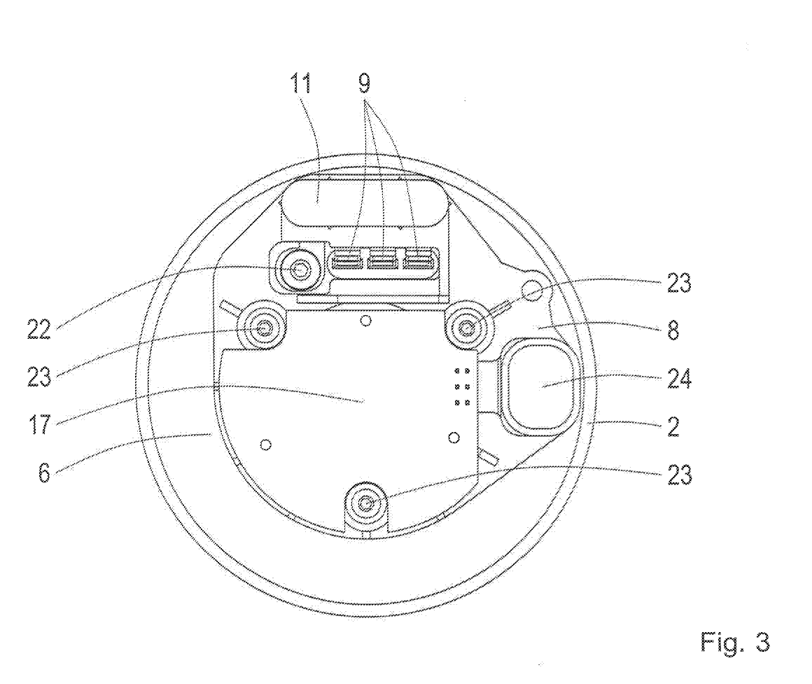

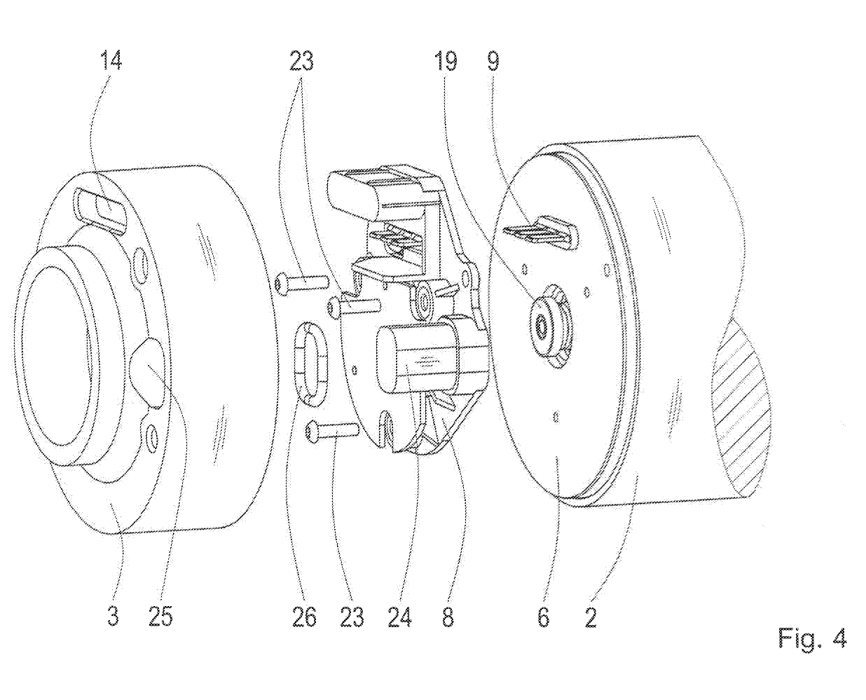

FIG. 3 shows a view from above—with the cover 3 removed—of the bearing plate 6, the printed circuit board 17 and the component carrier 8. As illustrated, the first plug collar 11 has an oval cross-section that corresponds to the cross-section of the power plug 15 (Fig, 1). In the drawing, under the plug collar 11 can be seen the three motor contacts 9 next to one another. On the left in the drawing, next to the motor contacts, is arranged a so-termed ground screw 22 which is electrically connected to the bearing plate 6 and thus to the motor housing 2, The purpose of the ground screw 22 is to connect to ground the screening of the power cable (not shown), i.e. by virtue of the ground screw 22 the screen is grounded. The component carrier 8 is screwed to the bearing plate 6 by three fixing screws 23. i.e. firmly connected thereto. On the component carrier 8, parallel to the plane of the drawing and the plane of the bearing plate 6, is arranged the printed circuit board which—as mentioned—is preferably connected to the component carrier 8 by hot-stamping. Offset by approximately 90 degrees in the circumferential direction a second plug collar 24 is arranged, this being an integral part of the component carrier 8, such that the plug collar 24 with its approximately rectangular cross-section serves to receive a second plug (not shown here) for a so-termed signal or sensor plug, as shown in FIG. 5.

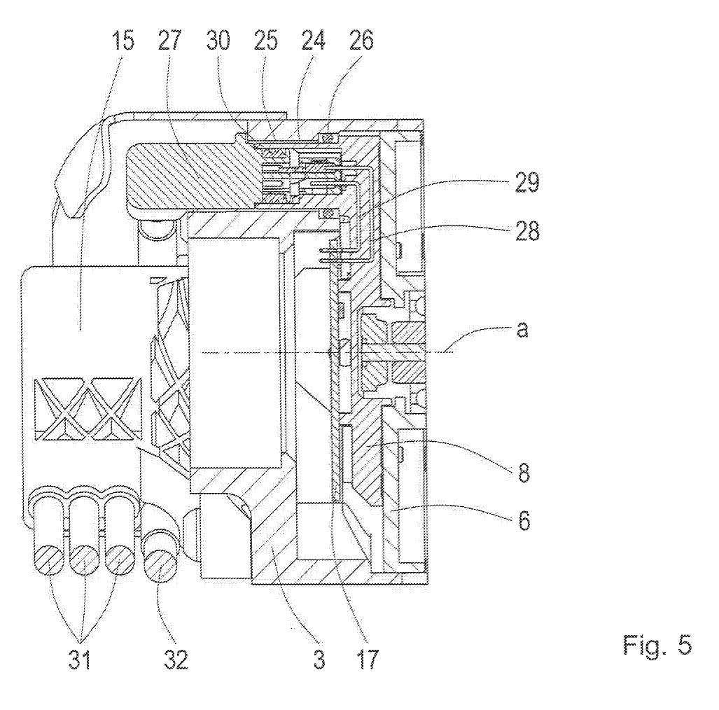

FIG. 4 shows an exploded view of the motor housing 2 with the bearing plate 6, the component carrier 8 and the cover 3, which in addition to the first opening 14 has a second opening 25 for the signal plug and the second plug collar 24. A sealing element 26 in the form of an O-ring serves to seal the second plug collar 24 relative to the second opening 25, i.e. relative to the cover 3. The fixing screws 23 are inserted through the component carrier 8, i.e., through corresponding screw bosses (not indexed) and screwed into the bearing plate 6.

FIG. 5 shows an axial section which is rotated through 90 degrees relative to the drawing plane of FIG. 1 and shows a second plug, namely a signal plug 27, which is inserted into the second plug collar 24 of the component carrier 8. The contacts of the signal plug (not indexed) are connected to the printed circuit board 17 by way of electrical conductors 28, 29 (leadframe). The signal plug 27 has a front area located in the second plug collar 24, which is sealed relative to the inside circumference of the second plug collar 24 by sealing means, preferably in the form of pressure ridges 30. The second plug collar 24 passes through the second opening 25 (see also FIG. 4) of the cover 3 and is sealed relative to the opening 25 by the O-ring 26 (see also FIG. 4). Thus, no moisture or water can make its way into the electronic space 7. The stabilizer half 4 is omitted here. On the outer and end side of the cover 3 cable guides can be seen, namely for three power cables 31 leading to the power plug 15 and one signal cable 32 leading to the signal plug 27. The cable guiding system is the object of the older application by the present applicant, mentioned at the beginning.

### INDEXES

1 Actuator
2 Motor housing
3 Cover
4 Stabilizer half
4a Sealing wall
5 Rotor shaft
6 Bearing plate
6a Recess
7 Hollow space
8 Component carrier
8a Centering extension
8b Opening
9 Motor contacts (power contacts)
10 Insulating body
11 First plug collar
12 Lamellar contacts
13 Electrical conductor
14 First opening (cover)
15 Power plug
15a Power contacts
16 Sealing element
17 Printed circuit board
˜Weld protection shield
19 Sender element
20 Receiver element
21 Plastic element
22 Ground screw
23 Fixing screws
24 Second plug collar
25 Second opening (cover)
26 O-ring
27 Signal plug
28 Conductor
29 Conductor
30 Pressure ridges
31 Power cable
32 Signal cable
a Rotational axis
A Centering: component carrier/bearing plate
B Rotation centering: component carrier/bearing plate
C Centering: plug collar/cover
D Centering: Cover/bearing plate

1-18. (canceled)

19. An electromechanical actuator comprising:
an electric motor with a rotor shaft (5) and a motor housing (2),
a bearing plate (6) being supported in the motor housing (2) for holding the rotor shaft (5),
a cover (3), which is connected to a stabilizer half (4), being located adjacent the motor housing (2) and the bearing plate (6), and
a component carrier (8), for at least one of electric and electronic components, being arranged on and fixed to the bearing plate (6).

20. The electromechanical actuator according to claim 19, wherein a first component, in a form of a power plug (15) for the electric motor, is provided on the component carrier.

21. The electromechanical actuator according to claim 19, wherein a second component, in a form of a signal plug (27), is provided on the component carrier.

22. The electromechanical actuator according to claim 19, wherein a third component, in a form of a sensor unit comprising a sender element and a receiver element (19, 20), is provided on the component carrier.

23. The electromechanical actuator according to claim 19, wherein a fourth component, in a form of a printed circuit board (17), is provided on the component carrier.

24. The electromechanical actuator according to claim 19, wherein the component carrier (8) has a first centering surface (A) arranged concentrically with an axis (a) of the rotor shaft (5), which is associated with a further centering surface of the bearing plate (6).

25. The electromechanical actuator according to claim 19, wherein the component carrier (8) has an eccentrically arranged centering surface (B), either motor or power contacts (9) are arranged on the bearing plate (6), and the component carrier (8) is fixed, in a circumferential direction, by the eccentrically arranged centering surface (B) and at least one of the motor contacts and the power contacts (9).

26. The electromechanical actuator according to claim 20, wherein the component carrier (8) has a first plug collar (11) for receiving the power plug (15).

27. The electromechanical actuator according to claim 21, wherein the component carrier (8) has a second plug collar (24) for receiving the signal plug (27).

28. The electromechanical actuator according to claim 26, wherein lamellar contacts (12) are arranged in the first plug collar (11) for forming an electric contact between the power plug (15) and at least one the motor or power contacts (9).

29. The electromechanical actuator according to claim 28, wherein the lamellar contacts (12) are supported relative to the bearing plate (6) by a plastic element (21).

30. The electromechanical actuator according to claim 26, wherein the cover (3) has a first opening (14) for receiving the first plug collar (11) and the power plug (15).

31. The electromechanical actuator according to claim 27, wherein the cover (3) has a second opening (25) for receiving the second plug collar (24) and the signal plug (27).

32. The electromechanical actuator according to claim 22, wherein the sender element (19) is connected to the rotor shaft (5) and is arranged within the first centering surface (A).

33. The electromechanical actuator according to claim 32, wherein the receiver element (20) is arranged coaxially with the sender element (19) on a printed circuit board (17), and is attached to the printed circuit board (17).

34. The electromechanical actuator according to claim 19, wherein the component carrier (8) is screwed to the bearing plate (6).

35. The electromechanical actuator according to claim 19, wherein the component carrier (8) has a weld protection shield (18) arranged between a printed circuit board (17) and at least one of either the electric motor or power contacts (9).

36. The electromechanical actuator according to claim 23, wherein the printed circuit board (17) is connected to the component carrier (8) by hot-stamping.

37. An electromechanical actuator comprising:
a rotor shaft of an electric motor being arranged within a motor housing:
a bearing plate being fixed to the motor housing for rotationally supporting the rotor shaft;
a cover mating with the motor housing and the bearing plate and being positioned on an axial side of the bearing plate opposite from the motor housing;
a stabilizer half being connected to the cover on an axial side of the cover opposite the bearing plate; and
a component carrier being fixed to the bearing plate, axially between the cover and the bearing plate, and the component carrier supporting at least one of electric and electronic components.
